(19) United States
(12) Patent Application Publication
(10) Pub. No.: US 2005/0133973 A1
(43) Pub. Date: Jun. 23, 2005

(54) Vehicle floor covering and method of making the same

(75) Inventors: Kenneth R. Parrish, Roseville, MI (US); Jean-Jacques Katz, Novi, MI (US)

Correspondence Address: BROOKS KUSHMAN P.C. / LEAR CORPORATION, 1000 TOWN CENTER, TWENTY-SECOND FLOOR, SOUTHFIELD, MI, 48075-1238, US

(73) Assignee: Lear Corporation, Southfield, MI (US)

(21) Appl. No.: 10/745,350

(22) Filed: Dec. 22, 2003

(51) Int. Cl. B32B 3/26; B05D 1/08; H05H 1/26; C23C 4/00; B28B 1/00; B28B 3/00; B28B 5/00; C04B 33/32; C04B 33/36; C04B 35/64

(52) U.S. Cl. 264/645; 427/446

(57) ABSTRACT

A non-pile carpet vehicle floor covering having a mass filled layer of variable thickness sprayed onto a polyurethane top surface. The method of making the vehicle floor covering comprises spraying a polyurethane layer over a mold release layer. A mass filled layer is then sprayed onto the polyurethane top layer before the polyurethane layer fully solidifies. A decoupler may be poured onto or adhesively attached to the mass filled layer. The mass filled layer may have thick areas and thin areas to provide varying levels of noise and vibration control as required by a particular vehicle application.

### BACKGROUND OF THE INVENTION

1. Field of the Invention

The present invention relates to a method of making a vehicle floor covering having a polyurethane top layer and a filled mass backing and a vehicle floor covering made in according to the method.

2. Background Art

Vehicle floor coverings are generally offered in carpet or non-carpet varieties. Traditionally, carpeted floor coverings are provided for passenger vehicle applications. Carpeted floors are generally considered to be more luxurious but are more difficult to maintain than non-carpeted floors due to the propensity for dirt and grease to accumulate in the pile of the carpet. Non-carpeted floors characterized by an elastomeric or rubber-like appearance are generally specified for trucks or work vehicles due to lower cost and easier maintainability. When a truck or utility vehicle is used at a work site, dirt, mud, grease and oil are commonly tracked into the vehicle on worker's shoes. Non-carpeted flooring allows foreign materials to be readily cleaned from the surface.

Sport utility vehicles and crossover vehicles in many situations could be made more desirable by providing a non-carpeted floor covering. Sport utility vehicles used for off road driving, hunting, fishing or other recreational activities are subject to accumulations of dirt, mud, oil, and grease much like work vehicles. If a consumer anticipates using a truck, sport utility vehicle, or crossover vehicle in such off road applications, they may prefer a non-carpeted floor covering.

Non-carpeted floor coverings tend to suffer from poor sound dampening and acoustics when compared to pile carpet floor coverings. Pile carpet floor coverings generally have better acoustics and provide more sound dampening than non-carpeted floor coverings.

The surface of non-carpeted floor coverings may be manufactured from polyurethane, vinyl, or other elastomeric compositions that tend to be relatively expensive. The elastomer layer of a vehicle floor covering is made of a durable material that can withstand normal wear and tear even though its thickness is less than 3.0 mm. Improving sound dampening and acoustics of non-carpeted vehicle floor coverings could be achieved by increasing the thickness of the elastomeric layer, however, increasing the thickness of an elastomer layer also increases the cost of the vehicle floor covering.

Vehicle floor coverings of either the carpeted or non-carpeted type are frequently installed in conjunction with a decoupler. The decoupler may be a shoddy, cast foam, or lightweight polyester batting. The decoupler may be glued or molded to the elastomeric layer. The shoddy may be glued with adhesive or may be attached without adhesive. A cast foam decoupler may be poured on an elastomeric layer. Polyester batting may be either glued or molded with or without an adhesive to the elastomeric layer.

There is a need for an easily cleanable vehicle floor covering that provides noise and vibration dampening comparable to carpeted floors without incurring excessive costs for elastomeric material. The present invention is directed to solving the above problems and overcoming the above-noted disadvantages as summarized below.

### SUMMARY OF THE INVENTION

One aspect of the present invention relates to a method of making a vehicle floor covering. The method comprises providing a mold having a forming surface on which a polyurethane composition is sprayed toward to form a polyurethane top layer of the floor covering. The polyurethane layer is partially cured to form a solid polyurethane top layer. A filled mass composition is sprayed onto the polyurethane top layer before the solid polyurethane top layer is fully cured to form a mass layer attached to the solid polyurethane top layer without penetrating the top layer. The polyurethane top layer and mass layer are cured to form a vehicle floor covering in the mold. The method is completed by removing the vehicle floor covering from the mold.

According to other aspects of the present invention as it relates to a method of making floor covering, the method may also include adding a decoupler next to the mass layer in the mold before removing the vehicle floor covering from the mold. The step of adding a decoupler may be performed by pouring a foam polyurethane composition onto the mass layer. Alternatively, the step of adding a decoupler may be performed by inserting a sheet form decoupler into the mold and onto the mass layer. As a further alternative, the decoupler may be added by inserting a lightweight polyester batting into the mold and onto the mass layer.

According to other aspects of the invention relating to spraying the mass layer, the step of spraying the mass layer may be performed by spraying the mass layer in a plurality of different thicknesses in specified areas of the mold to form a mass layer having greater thickness in some specified areas than in others. No adhesive is applied between the solid polyurethane top layer and the mass layer. The inherent properties of the solid polyurethane top layer and mass layer are utilized to bond these two layers together. The step of forming the polyurethane top layer may be performed using a reaction injection molding composition. The filled mass composition may be a filled ethyl vinyl acetate. The method may also further comprise trimming the outer edge of the floor covering after the floor covering is removed from the mold.

Another aspect of the invention relates to a vehicle floor covering. The vehicle floor covering comprises a polyurethane top layer having a top side and a bottom side. A filled mass composition is attached to the polyurethane top layer with the filled mass composition being partially disposed in the polyurethane top layer. The mass layer penetrates the bottom side but does not penetrate the solid polyurethane top layer to the top side.

Other aspects of the invention as they relate to the vehicle floor covering article comprise attaching the decoupler layer to the mass layer on the opposite side of the filled mass layer from the polyurethane top layer. The decoupler may be a poured foam composition, a lightweight polyester batting, or a sheet formed decoupler. The polyurethane top layer may be a reaction injection molding composition. The filled mass composition may be a filled ethyl vinyl acetate composition.

These and other aspects of the present invention will be better understood in view of the attached drawings and the following detailed description of certain specific embodiments of the invention.

### BRIEF DESCRIPTION OF THE DRAWINGS

FIG. 1 is a flow chart illustrating an embodiment of a method of making a vehicle floor covering;

FIG. 2 is a fragmentary cross-sectional view of a vehicle floor covering mold showing one embodiment of a set of layers used to form a vehicle floor covering; and

FIG. 3 is a fragmentary perspective view partially in cross section showing the mass filled layer of a non-pile carpet floor covering.

### DETAILED DESCRIPTION OF THE PREFERRED EMBODIMENT(S)

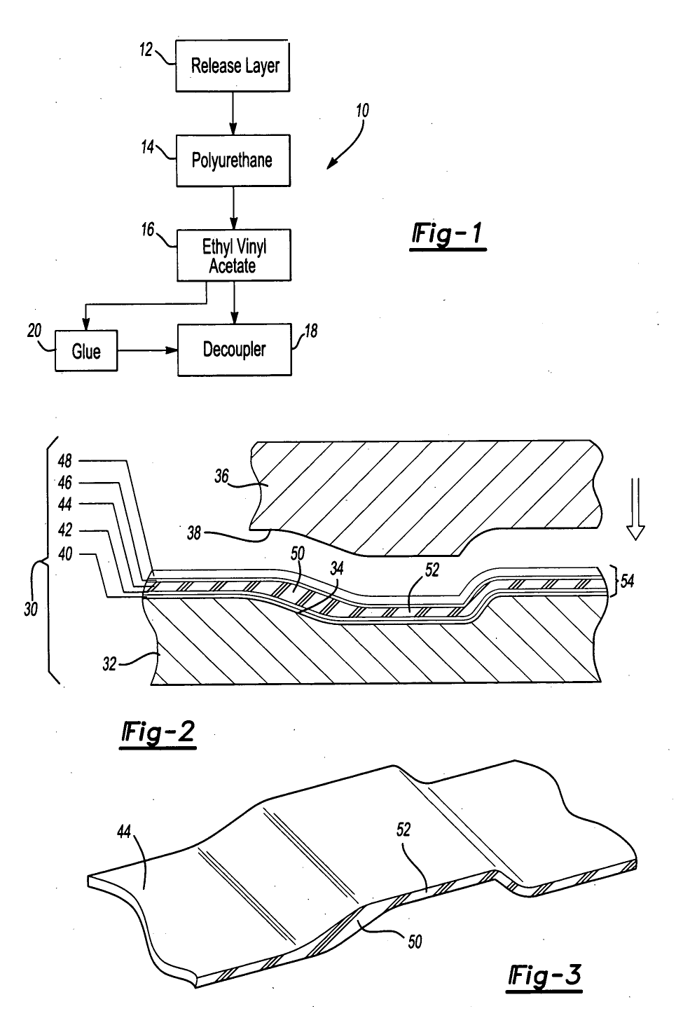

Referring now to FIG. 1, a method of making a non-pile carpet floor covering is generally referred to by reference numeral 10. The method is illustrated by means of a flow chart showing an exemplary set of process steps that may be used to make a vehicle floor covering. A release layer is applied to a mold, at 12. The release layer is applied to the mold to prevent the polyurethane that is sprayed toward the mold, at 14, from sticking to the mold. After the polyurethane layer is applied, at 14, a mass filled layer that may comprise, for example, ethyl vinyl acetate is sprayed or otherwise applied to the polyurethane layer before the polyurethane layer is fully cured but after it is partially cured so that the mass filled layer does not fully penetrate the polyurethane top layer of the floor covering. A decoupler is added to the mold, at 18, over the ethyl vinyl acetate or other mass filled layer. The decoupler may be added, for example, by pouring a foam polyurethane composition onto the mass layer. Alternatively, a sheet formed decoupler may be inserted into the mold and glue or adhesive may be applied, at 20, to cause the decoupler to adhere to the mass filled layer. The sheet formed decoupler may be a lightweight polyester batting. The polyurethane may be a spray polyurethane or a reaction injection molding composition that is appropriately placed into the mold and allowed to react to form the polyurethane layer.

Referring to FIG. 2, a mold 30 is shown to include a lower die 32 having a forming surface 34 that is used to form the top side of the vehicle floor covering. An upper die 36 may also be provided that has a back side forming surface 38. The upper die 36 may be used to apply compressive pressure to the layers that are placed in the mold 30 to form the floor covering. The mold 30 could also be an open mold that would not include an upper die 36 if it is not necessary to form or apply pressure to the back side of the floor covering.

The floor covering is formed by first applying a release layer 40 to the forming surface 34. The release layer 40 is preferably a commercially available mold release compound that prevents adhesion of polyurethane to the lower die 32. A polyurethane layer 42 is sprayed over the release layer 40 to form a continuous layer of polyurethane. This polyurethane layer 42 can be intentionally varied with respect to thickness to accommodate high wear areas like high foot contact regions. Notwithstanding, it has a nominal thickness in the range of 0.25-3.0 mm.

A mass filled layer 44 is then sprayed or otherwise applied over the polyurethane layer 42. The mass filled layer 44 may be ethyl vinyl acetate, or another asphaltic type composition. The mass filled layer preferably contains an inexpensive filler material. The mass filler layer provides mass behind the polyurethane layer 42 that improves the acoustics of the vehicle floor covering by allowing for added noise and vibration control. The mass layer is heavily filled to reduce the cost of the mass layer 44. A glue or adhesive material layer 46 may optionally be applied over the mass layer 44. A decoupler layer 48 may be adhered by the adhesive layer 46 to the mass layer 44 or may adhere to the mass filled layer if it has inherent adhesive properties in its partially cured state. The decoupler may be a poured foam polyurethane composition or may be added by inserting a sheet formed decoupler into the mold and adhered to the mass layer by means of a glue or adhesive layer 46 or by inherent adhesive properties.

As a further alternative, the decoupler may be a lightweight polyester batting material that is inserted into the mold and bonded to the mass layer 44 by means of the adhesive layer 46 or by inherent adhesive properties.

The mass layer 44 is shown in isolation in FIG. 3. In FIGS. 2 and 3, the mass layer is shown to include thick areas 50 and thinner areas 52. The thick areas may be provided in the mass layer in areas where additional noise and vibration control may be required. For example, the mass layer may be thicker on a portion of a floor pan extending over a differential or transmission housing. Thinner areas 52 may be provided where less noise and vibration control is required, for example under seats or over spare tire storage compartments and the like. By using a mass filled layer 44 having different thicknesses, tailored acoustic absorption may be obtained at a minimum cost without requiring excessive thickness of the polyurethane top surface material. The non-pile carpet floor covering material 54 comprises the polyurethane layer 42, mass filled layer 44, glue 46, and decoupler 48 that are shown in cross section in FIG. 2. The invention may also be practiced by providing a polyurethane layer 42 and mass layer 44 and eliminating the addition of the decoupler 48 in the mold. After the non-pile carpet vehicle flooring is formed in the mold 30, it is removed and may be trimmed or otherwise processed to finish manufacture of the vehicle floor covering article.

While embodiments of the invention have been illustrated and described, it is not intended that these embodiments illustrate and describe all possible forms of the invention. Rather, the words used in the specification are words of description rather than limitation, and it is understood that various changes may be made without departing from the spirit and scope of the invention.

1. A method of making a vehicle floor covering, comprising:
providing a mold having a forming surface;
spraying a polyurethane composition toward the forming surface to form a polyurethane top layer of the floor covering;
partially curing the polyurethane layer to form a solid polyurethane top layer;
spraying a filled mass composition onto the polyurethane top layer before the solid polyurethane top layer is fully cured to form a mass layer, wherein the mass layer does not fully penetrate the solid polyurethane top layer;
curing the polyurethane top layer and mass layer to form the vehicle floor covering in the mold; and
removing the vehicle floor covering from the mold.

2. The method of claim 1 further comprising:
adding a decoupler next to the mass layer in the mold before removing the vehicle floor covering from the mold.

3. The method of claim 2, wherein the step of adding the decoupler is performed by pouring a foam polyurethane composition onto the mass layer.

4. The method of claim 2, wherein the step of adding the decoupler is performed by inserting a sheet form decoupler into the mold and onto the mass layer.

5. The method of claim 2, wherein the step of adding the decoupler is performed by inserting lightweight polyester batting into the mold and onto the mass layer.

6. The method of claim 1, wherein the step of spraying the mass layer further comprising:
spraying the filled mass composition at a plurality of different thicknesses in specified areas of the mold to form a mass layer having greater thickness in some specified areas than in other areas.

7. The method of claim 1, wherein no adhesive is applied between the solid polyurethane top layer and the mass layer and the inherent properties of the solid polyurethane top layer and the mass layer are utilized to bond these two layers together.

8. The method of claim 1, wherein the polyurethane top layer is a reaction injection molding composition.

9. The method of claim 1, wherein the filled mass composition is filled ethyl vinyl acetate.

10. The method of claim 1, further comprising trimming the outer edge of the floor covering after the floor covering is removed from the mold.

11. A vehicle floor covering, comprising:
a polyurethane top layer having a top side and a bottom side; and
a filled mass composition attached to the polyurethane top layer with the filled mass composition being partially disposed in the polyurethane top layer, wherein the mass layer penetrates the bottom side but does penetrate the solid polyurethane top layer to the top side.

12. The vehicle floor covering of claim 11, further comprising a decoupler attached to the mass layer on the opposite side of the filled mass layer from the polyurethane top layer.

13. The vehicle floor covering of claim 12 wherein the decoupler is a poured foam composition.

14. The vehicle floor covering of claim 12 wherein the decoupler is a lightweight polyester batting.

15. The vehicle floor covering of claim 12 wherein the polyurethane top layer is a reaction injection molding composition.

16. The vehicle floor covering of claim 12, wherein the filled mass composition is filled ethyl vinyl acetate.
